(19) United States
(12) Patent Application Publication
(10) Pub. No.: US 2009/0228327 A1
(43) Pub. Date: Sep. 10, 2009

(54) RAPID STATISTICAL INVENTORY ESTIMATION FOR DIRECT EMAIL MARKETING

(75) Inventors: SIDDHARTHA ROY, KIRKLAND, WA (US); KRISHNAN V. SHANKAR, REDMOND, WA (US); DAVID M. CHICKERING, BELLEVUE, WA (US); CHRISTOPHER A. MEEK, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/044,568

(22) Filed: Mar. 7, 2008

(51) Int. Cl. G06Q 30/00; G06Q 10/00

(52) U.S. Cl. 705/10; 705/14

(57) ABSTRACT

Statistical approaches are employed to estimate available inventory for opt-in email marketing mailings. A random sample is selected from an overall population of subscribers who have opted-in to receiving email marketing messages. When a query is received for determining available inventory that satisfy some target criteria, the random sample is employed to estimate the available inventory in the overall population taking into account inventory that has been consumed by one or more other orders for email marketing mailings.

### BACKGROUND

Direct email marketing is a form of marketing in which messages are sent directly to consumers using electronic mail. In some instances, companies and individuals may send unsolicited bulk email to consumers, often referred to as spam. However, consumers typically find spam to be unwanted, and spamming has become an undesirable and, in some cases, illegal form of advertising. In other instances, opt-in email marketing is employed in which consumers have consented to receiving email advertising messages. In contrast to illicit spamming, opt-in email marketing has proven to be an effective and legitimate tool for delivering targeted messages to consumers.

In the case of opt-in direct email marketing, subscribers have elected to receive email advertisements. Often, subscribers provide information regarding their characteristics and interests and/or select to subscribe to particular lists or categories, such as sports, travel, entertainment, or health, for example. Accordingly, advertisements using opt-in direct marketing are often effective because they are targeted based on characteristics, attributes, and/or specific category selections of the subscriber audience.

Typically, an advertising system that provides opt-in email marketing will maintain an inventory of subscribers as well as information regarding the characteristics, attributes, and category selections of each subscriber. Advertisers wishing to create a particular mailing or a campaign (i.e., a set of mailings) contact the advertising system to determine availability of inventory for the mailing or campaign. Advertisers wish to check the availability of a particular audience segment (i.e., inventory with specific characteristics) and then have mailing(s) sent to this particular audience segment assuming availability of inventory. Advertisers typically seek inventory that satisfy one or more demographic attributes (e.g., age, gender, location), behavioral attributes (e.g., opened/clicked on previous mailing), and other attributes (e.g., subscriber was/was not part of a previous mailing). Additionally, advertisers often wish to have their mailing(s) delivered on specific day or days. The advertising system must provide information regarding available inventory to the requesting advertisers, and then fulfill orders by delivery emails to target subscribers. The process of determining available inventory is often complicated by competing orders and business policies restricting availability of inventory.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to using statistical approaches to estimate available inventory for opt-in direct email marketing mailings. Instead of querying an overall population to determine available inventory of opt-in subscribers for a mailing or campaign, a random sample is queried. The random sample comprises a random selection of subscribers from the overall population that reflects the composition of the overall population. When a query is received to determine available inventory that satisfy some target criteria, the random sample is employed to estimate the available inventory taking into account inventory that has been consumed by other orders.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram showing an overall environment for email direct marketing in accordance with an embodiment of the present invention;

FIG. 3 is a flow diagram showing an overall method for estimating available inventory in an overall population of inventory using a random sample in accordance with an embodiment of the present invention;

FIG. 4 is a flow diagram showing a method for using a random sample to estimate available inventory in an overall population after consumption of a portion of the inventory by previous orders in accordance with an embodiment of the present invention; and

FIG. 5 is a flow diagram showing a method for using a random sample to estimate available inventory in an overall population by removing subscribers from the random sample to represented consumed inventory in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to estimating available inventory for opt-in email marketing using statistical inventory estimation. In particular, random sampling techniques are used to estimate inventory available for advertising mailings and campaigns. Embodiments provide rapid inventory estimation while ensuring credible accuracy. The quick and reliable estimation provided by embodiments of the present invention allow for effective marketing and inventory management.

Accordingly, in one aspect, an embodiment of the present invention is directed to one or more computer-storage media embodying computer-useable instructions for performing a method. The method includes providing a random sample of an overall population of inventory of subscribers who have opted-in to receive direct email marketing messages. The method also includes receiving a request to determine available inventory in the overall population of inventory, the request specifying one or more target criteria. The method further includes using the random sample to determine the available inventory in the overall population having the one or more target criteria after at least a portion of the overall population has been consumed by one or more previous orders for inventory.

In another aspect of the invention, an embodiment is directed to one or more computer-storage media embodying computer-useable instructions for performing a method. The method includes providing a random sample from an overall population of inventory representing subscribers who have elected to receive email advertising messages from an advertising system. The random sample has a random sample size and the overall population has an overall population size. The method also includes receiving an order to send email advertising messages to at least a portion of the subscribers in the overall population. The order specifies one or more first target criteria and consumes at least a portion of the inventory satisfying the first target criteria. The method further includes receiving a query to determine available inventory in the overall population of inventory. The query specifies one or more second target criteria. The method also includes determining a number of subscribers in the random sample that satisfy the second target criteria. The method further includes determining a number of pair-wise intersections in the random sample between the order and the query by determining subscribers in the random sample satisfying the first target criteria and the second target criteria. The method still further includes estimating available inventory for the query based on the number of subscribers in the random sample that satisfy the second target criteria and the number of pair-wise intersections in the random sample.

In a further embodiment, an aspect of the invention is directed to one or more computer-storage media embodying computer-useable instructions for performing a method. The method includes providing a random sample from an overall population of inventory representing subscribers who have elected to receive email advertising messages from an advertising system. The random sample has a sample size and the overall population has an overall population size. The method also includes receiving an order to send email advertising messages to at least a portion of the subscribers in the overall population. The order specifies one or more first target criteria and a number of subscribers, wherein the order consumes at least a portion of the inventory satisfying the first target criteria. The method further includes removing subscribers from the random sample satisfying the first target criteria based on the number of subscribers specified by the order. The method also includes receiving a query to determine available inventory in the overall population of inventory, the query specifying one or more second target criteria. The method further includes determining a number of subscribers satisfying the second target criteria remaining in the random sample. The method still further includes extrapolating the number of subscribers satisfying the one or more second target criteria in the random sample from the random sample size to the overall population size to provide an estimate of available inventory for the query.

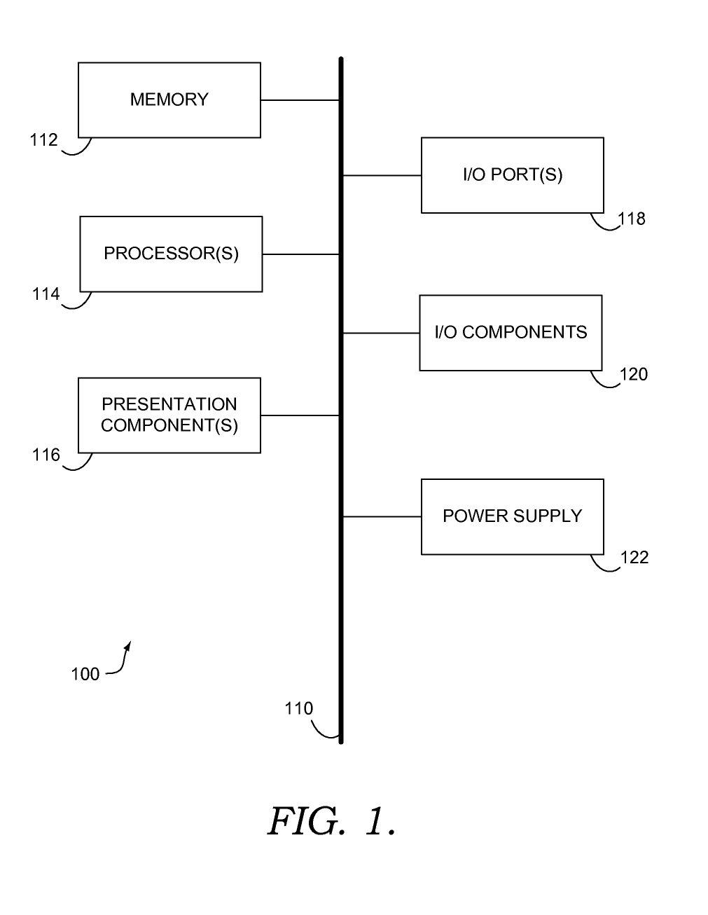

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

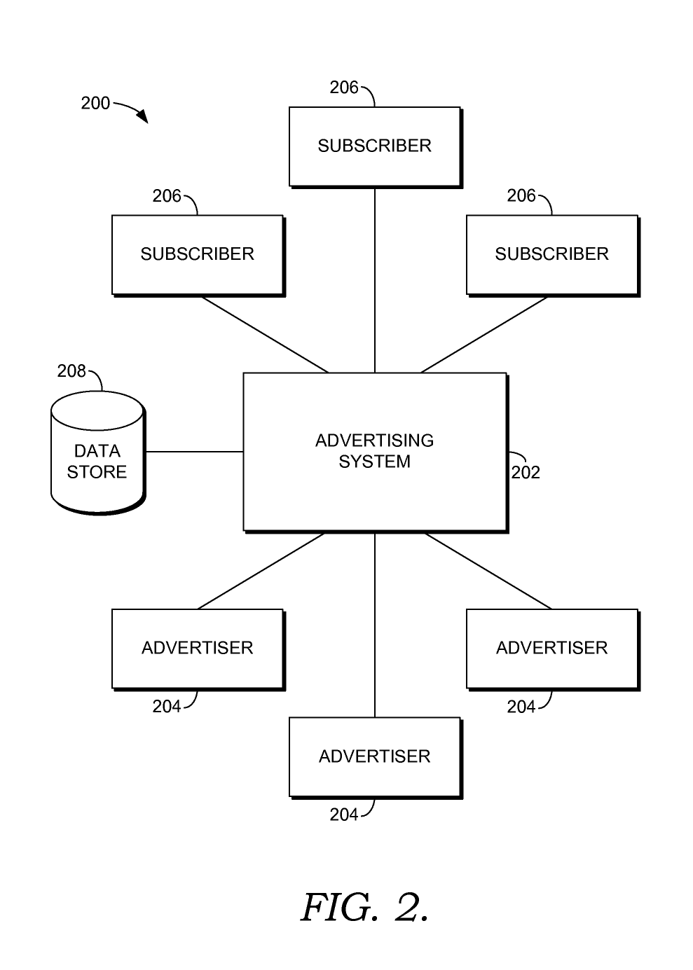

Referring now to FIG. 2, a block diagram is provided illustrating an overall environment 200 for providing opt-in direct email marketing in accordance with an embodiment of the present invention. As shown in FIG. 2, an advertising system 202 facilitates providing email advertising messages to subscribers, such as the subscribers 206 based on orders received from advertisers, such as the advertisers 204. Although only three subscribers 206 are shown in FIG. 2 for illustration purposes, those skilled in the art recognize that direct email marketing systems often include very large numbers of subscribers. Additionally, although three advertisers 204 are shown in FIG. 2 for illustration purposes, those skilled in the art recognize that any number of advertisers may submit orders for mailing(s) to the advertising system 202. Additionally, it should be understood the advertisers 204 may provide orders directly to the advertising system 202 or indirectly through, for instance, an advertising agency or other advertising entity.

Generally, a number of subscribers 206 may consent to receiving email advertisements from the advertising system 202. As is known in the art, subscribers 206 may consent in a variety of different ways. For instance, in some cases, subscribers 206 may provide consent directly to the advertising system 200. In other cases, subscribers 206 may provide consent to other entities, which then provide the subscribers' consent to the advertising system.

When subscribers 206 opt in to email marketing, the subscribers 206 may provide information describing their characteristics and attributes. For instance, subscribers 206 may be required to specify demographic information, such as age, gender, and location. Additionally, subscribers 206 may be required to specify information regarding their interests and hobbies. In some instances, subscribers 206 may be presented with a number of categories, such as sports, travel, entertainment, or health. The subscribers 206 may then select the categories for which they would like to receive email messages. For instance, if a subscriber 206 were to select only a health category, the subscriber 206 would only receive email messages relevant to health and would not receive email messages relevant to other categories, such as sports, travel, and entertainment. Subscribers 206 may select one, multiple, or all categories depending on their interests.

The advertising system 202 may also generate and maintain information regarding the subscribers 206. For instance, the advertising system 202 may maintain information regarding subscribers' behavioral attributes, such as whether subscribers 206 opened previous emails or whether subscribers 206 clicked links to additional advertising information included in emails. The advertising system 202 may also maintain other information, referred to herein as “meta” attributes regarding the subscribers 206, such as whether subscribers 206 were part of specific previous mailings.

The advertising system 202 may store information regarding the subscribers in one or more data stores, such as the data store 208 shown in FIG. 2. Generally, the data store 208 may store information including information identifying a subscriber 206 (e.g., a unique subscriber identifier or the subscriber's name), an email address for the subscriber 206, and subscriber attributes, including the subscriber-provided and system-generated attributes discussed above.

The information stored in the data store 208 may be viewed as inventory for the advertising system 202 as the subscribers 206 represent targets for advertisements for the advertisers 204. Each time an email message may be sent to a subscriber 206 is counted as an inventory. For instance, a subscriber 206 may subscribe to multiple categories such that the subscriber 206 would be considered as inventory for each category. Additionally, the number of inventory may be dictated by business rules that indicate the number of times a subscriber 206 may receive an email. For instance, a business rule could indicate that a subscriber 206 may receive an email once a day, week, etc. Thus, the number of available inventory would be affected by such business rules.

When advertisers 204 wish to create a particular mailing or campaign, the advertisers 204 place orders with the advertising system 202. The orders may specify target criteria, such as attributes of the subscriber audience that the mailing or campaign is directed towards. For instance, an advertiser 204 may specify that a particular mailing should be directed to males between the ages of 18-30. In some embodiments, the advertiser 204 may specify or the advertising system 202 may determine a category for the mailing. For instance, the advertisement may relate to a new sports magazine such that the sports category is selected for the mailing. If the advertising system 202 maintains separate lists for different categories, then only the inventory list for the sports category would be used to select inventory for the mailing. In some cases, the advertiser 204 may further specify a number of subscribers 206 to which the mailing should be sent. For instance, an advertiser 204 may specify that a mailing should be sent to 10,000 subscribers.

When an advertiser 204 places an order or prior to an advertiser 204 placing an order, the advertising system 202 may determine whether there is inventory available to fulfill the advertiser's requirements. Availability of inventory is subject to the advertising system 202 having enough subscribers 206 that meet the advertiser's specified criteria. In instances in which the advertising system 202 maintains lists for different categories, availability of inventory is subject to the selected list(s) having enough subscribers 206 that meet the specified criteria. Determination of available inventory is complicated by previous orders from other advertisers 204. Additionally, determination of available inventory is further complicated by business rules, such as frequency capping and non-compete restrictions, which restrict inventory availability based on various policies, such as excluding previous recipients of emails, limiting the number of emails to particular subscribers, and taking into account any user opt-out policies.

In accordance with embodiments of the present invention, the advertising system 202 estimates inventory available to advertisers based on statistical principles. Instead of working with actual size data sets, the advertising system 202 works on a random sample of the overall inventory (or overall inventory in a list for a category) provided by the advertising system 202. Available inventory is estimated using queries on the random sample.

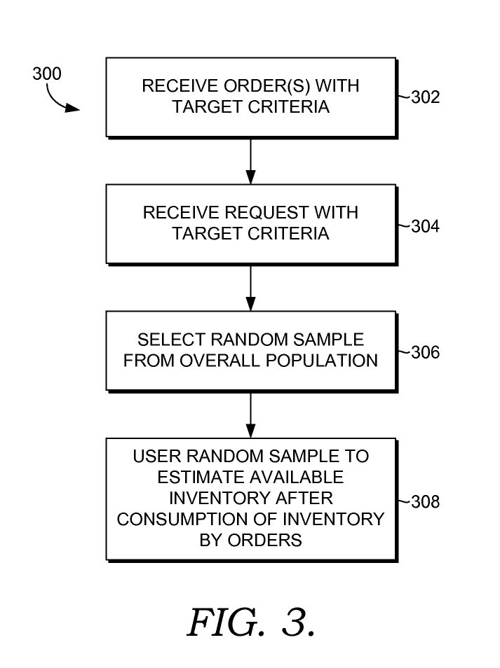

Turning now to FIG. 3, a flow diagram is provided illustrating an overall method 300 for estimating inventory availability using statistical principles in accordance with an embodiment of the present invention. Initially, as shown at block 302, any number of orders for direct email marketing inventory are received by an advertising system, such as the advertising system 202 of FIG. 2. Generally, each order may be provided by an advertiser and may specify particular criteria for selecting subscribers for a given mailing or campaign. As indicated previously, the criteria specified by an advertiser may be based on, for instance, subscriber demographics, subscriber behavioral attributes, and other meta attributes for subscribers. An advertiser may also specify a time period for a mailing or campaign, as well as the number of subscribers to which the mailing(s) should be sent. Accordingly, each order potentially reduces the availability of inventory for other orders.

At block 304, a request for inventory is received by the advertising system. The request may specify criteria, such as subscriber demographics, subscriber behavioral attributes, other meta attributes for subscribers, a time period, and/or a desired number of subscribers. In some instances, the request may be an order from an advertiser. In other instances, the request may simply be a query to determine available inventory having specific characteristics. For instance, an advertiser may wish to know how much inventory meeting its criteria would be available for a mailing when determining whether to proceed with the mailing. Additionally, an advertiser may wish to determine the available inventory for multiple queries with different criteria to determine which is the most suitable for the advertiser's purposes.

A random sample of an overall population of inventory is selected, as shown at block 306, by randomly selecting subscribers from the overall population to include in the random sample. In some embodiments, the overall population may be the entire population of inventory for the advertising system, while in other embodiments, the overall population may be inventory included in list for a category. The random sample may be selected at the time the request is received or may have been pre-selected.

The selection of the random sample may include a determination of the sample size (i.e., the number or percentage of subscribers from the overall population to include in the random sample). The size of the random sample affects how well the random sample represents the overall population, thereby affecting the accuracy of estimations performed using the random sample. Additionally, the size of the random sample affects the ability to perform rapid estimations. For instance, a very large sample size relative to the overall population may provide accurate estimates as the random sample accurately reflects the overall population. However, it may not be possible to perform rapid estimations using a random sample having such a large sample size. Alternatively, a very small sample size relative to the overall population allows for very rapid estimations to be performed but may not provide accurate estimations as the random sample is too small to accurately reflect the overall population. Accordingly, in some embodiments, a sample size is selected to provide a random sample that allows for both accurate and rapid estimations.

In some embodiments, a sample size is selected such that the variance between the random sample and the overall population is within an acceptable tolerance limit to provide sufficiently reliable results. The tolerance limit may be selected by an advertising system and/or an advertiser based on the level of accuracy and efficiency desired. Although embodiments of the present invention are not limited to such ranges, it has been determined that a variance of between five percent and eight percent has provided desirable results. In various embodiments of the invention, a sample size for a random sample may be determined based on a variety of factors, such as the size of the overall population, the nature of attributes of subscribers within the overall population, and attribute value distributions within the overall population.

The sample size for a random sample may be determined empirically in some embodiments of the present invention. For instance, in one embodiment, a test population of a given size may be taken from the overall population. The attribute value distributions in the test population are compared against the attribute value distributions in the overall population. For instance, the percentage of males in the test population may be compared against the percentage of males in the overall population. In some cases, attribute value distributions may be compared for all attributes. However, given a large number of available attributes, such an approach may be undesirable. Accordingly, in other cases, attribute value distributions are compared only for selected attributes. Because different lists may have biases in particular attributes (e.g., a list for male health may include mainly male subscribers), attributes to be used for comparison may be selected based on the lists' biases such that attributes that will accurately determine whether the test population reflects the overall population are used. If the variance between the test population and the overall population is within an acceptable tolerance limit, the size of the test population may be considered acceptable for the random sample.

In another embodiment, instead of or in addition to comparing a test population against the overall population, multiple test populations may be compared against one another to determine an acceptable sample size. For instance, several test populations of a given size may be selected from the overall population. Attribute value distributions between the test populations may then be compared, similar to the comparisons discussed above between a test population and the overall population. If the variance between the test populations is within an acceptable tolerance limit, the sample size of the test populations may be considered acceptable for the random sample.

Although embodiments of the present invention are not limited to such ranges, it has been determined that a sample size between two percent and six percent of the overall population size provides accurate results. Additionally, in some embodiments, the sample size as a percentage of the overall population size may be inversely proportional to the overall population size. For instance, a larger percentage for a small overall population (e.g., 5% of 100,000) may produce a sample size that is smaller than a smaller percentage for a large overall population (e.g., 2% of one million).

A threshold sample size may also be employed in some embodiments based on the need to restrict a sample size for efficiency purposes to provide rapid estimations. Generally, the threshold sample size reflects the largest number of subscribers a random sample may contain. The threshold sample size for a given overall population may be based on the size of that overall population, such that a larger overall population may have a larger threshold sample size and vice versa. For instance, in one embodiment, smaller overall populations may have a threshold sample sizes as small as 1,000 while a larger overall populations may have threshold sample sizes as large as 60,000.

As shown at block 308, available inventory in the overall population meeting the target criteria for the request received at block 304 is estimated using the random sample. The estimation of available inventory accounts for consumption of inventory by the other orders received at block 302.

Available inventory may be estimated using a random sample of an overall population of inventory in a variety of different manners within the scope of embodiments of the present invention. Generally, an inventory subtraction algorithm may be employed that handles subtraction of previously booked orders to determine how much inventory is remaining for a new order or query. Several approaches will now be discussed in more detail for purposes of illustration of some embodiments. As will be appreciated by one with ordinary skill in the art, the method by which previous orders are subtracted from the sample inventory should be informed by the details of the algorithm used to actually allocate the inventory at the time of delivery. The subtraction method described here approximates the inventory that will remain assuming that (1) the delivery engine satisfies orders sequentially (i.e., in the order in which they entered the system), and (2) the inventory allocated to each order is a random sample of the remaining inventory that matches that order's targeting criteria (that is, subsequent orders are not used to inform which inventory is allocated to the current order).

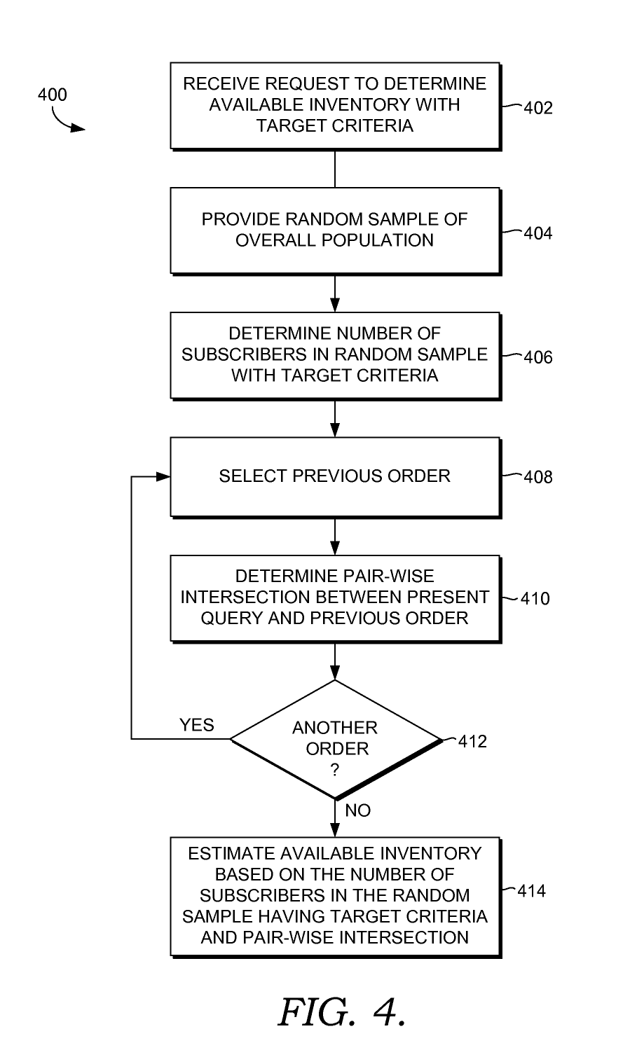

Referring initially to FIG. 4, a flow diagram is provided showing a method 400 for estimating available inventory using a random sample in accordance with one embodiment of the present invention. As shown at block 402, a request is received to determine available inventory. The request may specify target criteria, such as subscriber demographics, subscriber behavioral attributes, other meta attributes for subscribers, a time period, and/or a desired number of subscribers.

A random sample of an overall population is provided at block 404. At block 406, a number of subscribers satisfying the target criteria within the random sample is determined. Extrapolating this number from the sample size to the overall population size would provide an estimate of the number of subscribers in the overall population having the target criteria. For instance, if the sample size was 3% of the overall population size, and it was determined that the random sample contained 7,500 subscribers satisfying the target criteria, the overall population would be estimated to have 250,000 subscribers satisfying the query. However, a portion of these subscribers may have been consumed by other orders. Accordingly, to determine inventory consumed by another order, a previous order is selected at block 408. In some embodiments, the process may include determining those orders that affect the current query based on, for instance, a time period for the orders and the query and/or based on other business policies controlling how other orders affect consumption of inventory for the present query. For instance, only orders that cause inventory to be consumed for a day specified in the current query may be considered.

The number of pair-wise intersections in the random sample between the present query and the previous order is determined at block 410. In particular, based on the criteria specified by the present request and the criteria specified by the previous order, a determination is made regarding the number of subscribers in the random sample that meet the criteria from both the present request and the previous order.

As shown at block 412, it is determined whether there is another previous order that consumes inventory for the present query. If there is another order, the process from block 408 to block 410 is repeated for the next order to determine the pair-wise intersection between the present query and the next previous order. Accordingly, the method from block 408 to block 412 is repeated until all relevant orders have been processed.

As shown at block 414, the available inventory for the query is estimated based on the number of subscribers in the random sample having the criteria of the present query determined at block 406 and the number of pair-wise intersections in the random sample determined at block 410. The available inventory may be estimated at block 414 in different ways in some embodiments of the present invention. In one embodiment, the number of pair-wise intersections in the random sample determined at block 410 for each previous order is subtracted from the number of subscribers in the random sample having the criteria of the present query determined at block 406. The difference is then extrapolated from the random sample size to the overall population size to provide an estimate of available inventory for the query. For instance, continuing the previous example in which 7,500 subscribers in the random sample satisfied the present query's criteria, suppose that there was only one previous order and that it was determined that the pair-wise intersections for the present query and the previous order was 1,500 subscribers. Accordingly, the difference would be 6,000. Extrapolating this number from the sample size to the overall population size (assuming that the sample size is 3% of the overall population size), the number of inventory estimated to be available for the present query would be 200,000 subscribers.

In another embodiment, the number of pair-wise intersections in the random sample determined at block 410 for each previous order and the number of subscribers in the random sample having the criteria of the present query determined at block 406 are first each extrapolated from the random sample size to the overall population size. The extrapolated pair-wise intersection number(s) are then subtracted from the extrapolated number of subscribers having the criteria of the present query to provide an estimate of available inventory for the query. For instance, in the previous example in which 7,500 subscribers in the random sample satisfied the present query's criteria, the pair-wise intersections in the random sample for the present query and the previous order was 1,500 subscribers. Extrapolating each number to the overall population would provide 250,000 and 50,000 subscribers, respectively. As such, the number of inventory estimated to be available for the present query would be the difference or 200,000 subscribers.

By way of further illustration, suppose for instance, that an advertising system has a list with an inventory size of 1 million. A random sample is drawn from the database in a manner such as that described hereinabove such that the sample is representative of the full list. In the present example, the random sample has an inventory size of 30,000 such that the sample inventory size is 3% of the full inventory size.

The advertising system receives a first query from a first advertiser: “How many males between the age of 18-24 exist in this list?” The query if first performed on the sample of 30,000 to determine the number of subscribers within the sample inventory that are males between the age of 18 and 24. In the present example, it is determined that 7,500 of the 30,000 subscribers in the random sample are males between the age of 18-24. The result is then extrapolated to the full list size. Accordingly, based on the 7,500 subscribers meeting the criteria in the random sample, the total list would be estimated to have 250,000 subscribers who are males between the age of 18 and 24.

Suppose further that the advertiser agrees to reserve the entire 250,000 for a given date. Additionally, suppose that the business policy dictates that once a mailing is sent out to a subscriber on a list on a given day, that subscriber is not available for further mailings on the same day. Accordingly, based on the first advertiser's order, the reserved inventory would not be available for other orders. As such, when a second advertiser provides a query for inventory on the same day, the first advertiser's order may reduce the available inventory for the second advertiser's query.

For instance, suppose that the second advertiser wishes to send mailings to subscribers living in Washington state on the same day as that reserved by the first advertiser. To estimate the available inventory, the advertising system needs to not only calculate how many subscribers live in Washington but also needs to find out how many in this segment were already consumed in the first order. Accordingly, two estimates are performed. One estimation, E1, is the number of subscribers consumed in the first booking who are males, between the age of 18 and 24, and live in Washington. The second estimation, E2, is the number of subscribers living in Washington. The estimated available inventory for the second advertiser's query would be the difference between the two estimations: E2−E1.

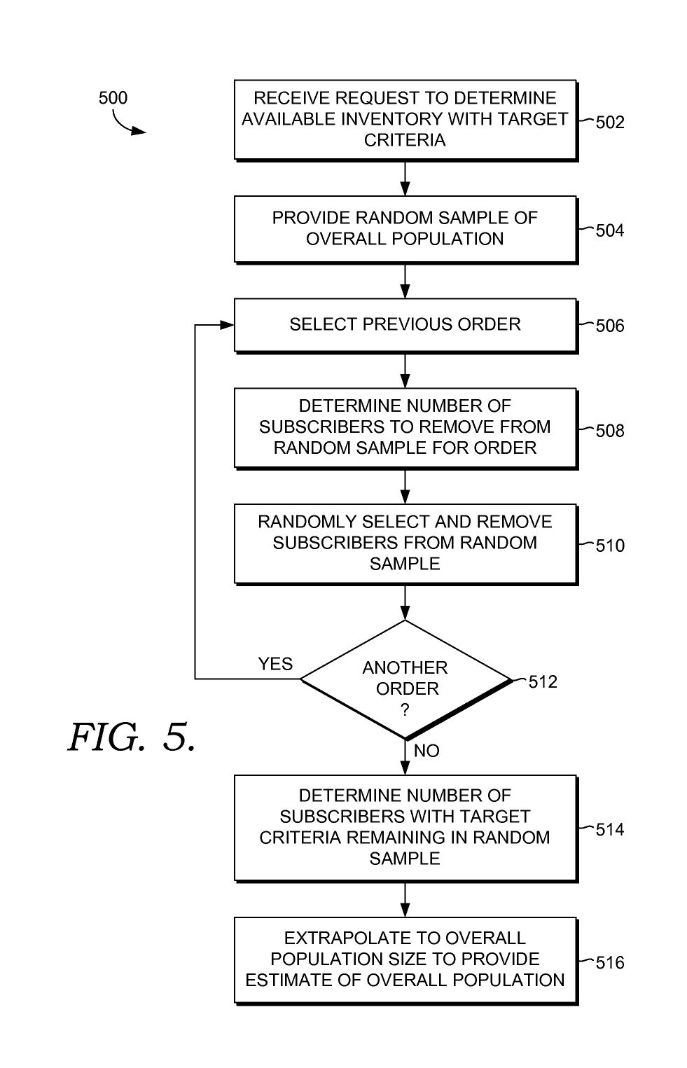

In another embodiment of the present invention, available inventory may be estimated for a query by first removing inventory from a random sample based on previous orders and then using the random sample to estimate available inventory for the query. For instance, with reference to FIG. 5, a flow diagram is provided illustrating a method 500 for estimating available inventory using a random sample by representing consumed inventory in the sample in accordance with an embodiment of the present invention. Initially as shown at block 502, a request is received to determine available inventory. The request may specify criteria, such as subscriber demographics, subscriber behavioral attributes, other meta attributes for subscribers, a time period, and/or a desired number of subscribers.

A random sample of an overall population is provided at block 504. As indicated previously, to estimate available inventory in the present embodiment, inventory is first removed from the random sample to represent the inventory in the overall population that has been consumed by other orders. Accordingly, as shown at block 506, a previous order is selected. In some embodiments, the process may include determining those orders that affect the current query based on, for instance, a time period for the orders and the query and/or based on other business policies controlling how other orders affect consumption of inventory for the present query. For instance, only orders that cause inventory to be consumed for a day specified in the current query may be considered.

The number of subscribers to remove from the random sample is determined based on the inventory in the overall population consumed by the order, as shown at block 508. The determined number of subscribers having the criteria specified by the order are then randomly selected and removed from the random sample, as shown at block 510. For instance, suppose an the order consumes 50,000 subscribers who live in Washington and the sample size is 3% of the overall population size. In the present example, 1,500 subscribers who live in Washington would be randomly selected and removed from the random sample. After removing subscribers from the random sample based on the criteria of the order, the random sample represents the overall population after inventory has been consumed by that order.

As shown at block 512, it is determined whether there is another previous order that consumes inventory for the present query. If there is another order, the process from block 506 to block 510 is repeated for the next order to remove subscribers in the random sample to represent consumption in the overall population for that order. Accordingly, the method from block 506 to block 512 is repeated until all relevant orders have been processed.

Once it is determined that there are no more relevant orders at block 512, a number of subscribers remaining in the random sample that meet the criteria specified by the present query is determined, as shown at block 514. The number in the random sample is then extrapolated to the overall population size to provide an estimate of available inventory for the query, as shown at block 516.

As can be understood, embodiments of the present invention provide for rapid inventory estimation for direct email marketing by using random samples to estimate inventory consumption and availability for future mailings or campaigns. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-storage media embodying computer-useable instructions for performing a method comprising:
providing a random sample of an overall population of inventory of subscribers who have opted-in to receive direct email marketing messages;
receiving a request to determine available inventory in the overall population of inventory, the request specifying one or more target criteria; and
using the random sample to determine the available inventory in the overall population having the one or more target criteria after at least a portion of the overall population has been consumed by one or more previous orders for inventory.

2. The one or more computer-storage media of claim 1, wherein the overall population of inventory comprises a list of subscribers who have subscribed to a particular category for receiving direct email marketing messages having content relevant to the category.

3. The one or more computer-storage media of claim 1, wherein providing a random sample comprises:
determining a sample size; and
randomly selecting subscribers from the overall population to generate the random sample having the sample size.

4. The one or more computer-storage media of claim 3, wherein determining the sample size comprises determining the sample size such that a variance between the random sample and the overall population is within a predetermined tolerance limit.

5. The one or more computer-storage media of claim 3, wherein the sample size is determined based on at least one of the following: a size of the overall population and attribute value distributions within the overall population.

6. The one or more computer-storage media of claim 3, wherein the sample size is determined based on a threshold sample size that indicates a largest number of subscribers the random sample may contain.

7. The one or more computer-storage media of claim 1, wherein the one or more target criteria specify at least one of the following: a demographic attribute of a subscriber and a behavioral attribute of a subscriber.

8. The one or more computer-storage media of claim 1, wherein the method further comprises:
receiving an order from an advertiser based on the available inventory, the order specifying the one or more target criteria and a number of subscribers for receiving an email advertisement for the advertiser;
selecting subscribers from overall population based on the order; and
sending the email advertisement to each of the selected subscribers.

9. One or more computer-storage media embodying computer-useable instructions for performing a method comprising:
providing a random sample from an overall population of inventory representing subscribers who have elected to receive email advertising messages from an advertising system, the random sample having a random sample size and the overall population having an overall population size;
receiving an order to send email advertising messages to at least a portion of the subscribers in the overall population, the order specifying one or more first target criteria and consuming at least a portion of the inventory satisfying the one or more first target criteria;
receiving a query to determine available inventory in the overall population of inventory, the query specifying one or more second target criteria;
determining a number of subscribers in the random sample that satisfy the one or more second target criteria;
determining a number of pair-wise intersections in the random sample between the order and the query by determining subscribers in the random sample satisfying the one or more first target criteria and the one or more second target criteria; and
estimating available inventory for the query based on the number of subscribers in the random sample that satisfy the one or more second target criteria and the number of pair-wise intersections in the random sample.

10. The one or more computer-storage media of claim 9, wherein estimating available inventory for the query comprises:
determining a difference between the number of subscribers in the random sample that satisfy the one or more second target criteria and the number of pair-wise intersections in the random sample; and
extrapolating the difference from the random sample size to the overall population size to provide an estimate of available inventory for the query.

11. The one or more computer-storage media of claim 9, wherein estimating available inventory for the query comprises:
extrapolating the number of subscribers in the random sample that satisfy the one or more second target criteria from the random sample size to the overall population size to provide an estimated number of subscribers in the overall population that satisfy the one or more second target criteria;
extrapolating the number of pair-wise intersections in the random sample from the random sample size to the overall population size to provide an estimated number of consumed subscribers in the overall population; and
determining a difference between the estimated number of subscribers in the overall population that satisfy the one or more second target criteria and the estimated number of consumed subscribers in the overall population to provide an estimate of available inventory for the query

12. The one or more computer-storage media of claim 9, wherein the method further comprises receiving a plurality of additional orders, each additional order specifying a set of target criteria and a number of subscribers.

13. The one or more computer-readable media of claim 12, wherein the method further comprises determining one or more of the additional orders that affect the query.

14. The one or more computer-storage media of claim 13, wherein the method further comprises determining a number of pair-wise intersections in the random sample between the query and each of the one or more additional orders.

15. The one or more computer-storage media of claim 14, wherein estimating available inventory for the query is further based on the number of pair-wise intersections in the random sample between the query and each of the one or more additional orders.

16. One or more computer-storage media embodying computer-useable instructions for performing a method comprising:
providing a random sample from an overall population of inventory representing subscribers who have elected to receive email advertising messages from an advertising system, the random sample having a sample size and the overall population having an overall population size;
receiving an order to send email advertising messages to at least a portion of the subscribers in the overall population, the order specifying one or more first target criteria and a number of subscribers, wherein the order consumes at least a portion of the inventory satisfying the one or more first target criteria;
removing subscribers from the random sample satisfying the one or more first target criteria based on the number of subscribers specified by the order;
receiving a query to determine available inventory in the overall population of inventory, the query specifying one or more second target criteria;
determining a number of subscribers satisfying the one or more second target criteria remaining in the random sample; and
extrapolating the number of subscribers satisfying the one or more second target criteria in the random sample from the random sample size to the overall population size to provide an estimate of available inventory for the query.

17. The one or more computer-storage media of claim 16, wherein removing subscribers from the random sample based on the order comprises determining a number of subscribers to remove from the random sample based on the number of subscribers specified by the order and the sample size of the random sample.

18. The one or more computer-storage media of claim 16, wherein the method further comprises receiving a plurality of additional orders, each additional order specifying a set of target criteria and a number of subscribers.

19. The one or more computer-readable media of claim 18, wherein the method further comprises determining one or more of the additional orders that affect the query.

20. The one or more computer-storage media of claim 19, wherein the method further comprises removing subscribers satisfying the set of target criteria based on the number of subscribers specified by each of the one or more additional orders.
